(19) United States
(12) Patent Application Publication
(10) Pub. No.: US 2026/0341783 A1
(43) Pub. Date: Oct. 29, 2026

(54) MANUFACTURING METHOD OF SOLID ELECTROLYTE, SOLID ELECTROLYTE MANUFACTURED THEREFROM, AND SECONDARY BATTERY COMPOSING THE SAME

(71) Applicant: SK On Co., Ltd., Seoul (KR)

(72) Inventor: Jung Hyun PARK, Daejeon (KR)

(21) Appl. No.: 19/655,725

(22) Filed: Apr. 23, 2026

(30) Foreign Application Priority Data
Apr. 24, 2025 (KR) 10-2025-0053760

(51) Int. Cl. H01M 10/0562

(52) U.S. Cl. CPC H01M 10/0562; H01M 2300/0068

(57) ABSTRACT

The present disclosure relates to a manufacturing method of a solid electrolyte, a solid electrolyte manufactured therefrom, and a secondary battery including the same, wherein the manufacturing method of a solid electrolyte according to an aspect may include: preparing a solid electrolyte precursor; and controlling a particle diameter of the solid electrolyte precursor, wherein the controlling the particle diameter may be performed at a temperature of 0 °C or lower.

### CROSS-REFERENCE TO RELATED PATENT APPLICATION

The present application claims priority under 35 U.S.C. § 119(a) to Korean patent application number 10-2025-0053760 filed on Apr. 24, 2025, in the Ministry of Intellectual Property, the entire disclosure of which is incorporated by reference herein.

### BACKGROUND OF THE INVENTION

### 1. Field

The present disclosure relates to a manufacturing method of a solid electrolyte, a solid electrolyte manufactured therefrom, and a secondary battery including the same.

### 2. Description of the Related Art

A secondary battery includes a positive electrode and a negative electrode and may further include an electrolyte that is a means for mediating movement of ions between the positive electrode and the negative electrode. When a solid electrolyte is used as the electrolyte, various advantages may be obtained, such as excellent safety due to a lack of flammable organic solvents compared to a case where a liquid electrolyte is used as well as reduced volume which makes it advantageous in terms of energy density. Of solid electrolytes, sulfide-based solid electrolytes have ionic conductivity comparable to that of organic liquid electrolytes, and thus have recently attracted attention owing to their excellent mechanical ductility.

In the manufacturing process of solid electrolytes, mechanical grinding has been generally used, where the solid electrolyte produced by the commonly used mechanical grinding method may have a particle diameter of several tens of micrometers (μm). This results in a thicker solid electrolyte layer in secondary batteries, which may directly lead to a decrease in secondary battery performance, including a decrease in the energy density of the secondary battery.

Attempts have been made to obtain solid electrolytes with a particle diameter of several micrometers (μm) by applying additional particle diameter control processes to the obtained solid electrolyte, and the current attempts may be broadly categorized into dry and wet methods. However, in the case of the conventional dry method, the process is simple by not using organic solvents, but the long processing (crushing) and intense energy applied to the material may cause a drop in the crystallinity of the surface and a decrease in the ionic conductivity; and, in the case of the conventional wet method, there rises a problem in that the process is complicated with a long processing time due to the additional post-process that involves solvent addition followed by drying.

### SUMMARY OF THE INVENTION

According to an aspect of the present disclosure, a manufacturing method of a solid electrolyte may be provided, which enables preparation of a solid electrolyte with an excellent performance through a process that is simple and economically feasible.

According to another aspect of the present disclosure, a solid electrolyte exhibiting excellent particle diameter properties and ionic conductivity may be provided.

According to another aspect of the present disclosure, a secondary battery having improved output characteristics, charge/discharge properties, lifespan, and safety may be provided.

The present disclosure may be widely applied in the field of electric vehicles, battery charging stations, energy storage systems (ESS), and other green technologies such as photovoltaics and wind power utilizing batteries. The present disclosure may also be used in eco-friendly mobility, including electric vehicles and hybrid vehicles, to prevent climate change by reducing air pollution and greenhouse gas emissions.

A manufacturing method of a solid electrolyte according to the present disclosure may include: preparing a solid electrolyte precursor; and controlling a particle diameter of the solid electrolyte precursor, wherein the controlling the particle diameter may be performed at a temperature of 0 °C or lower.

In the manufacturing method of a solid electrolyte according to an embodiment, the solid electrolyte may be a sulfide-based solid electrolyte.

In the manufacturing method of a solid electrolyte according to an embodiment, the sulfide-based solid electrolyte may include argyrodite-type sulfide.

In the manufacturing method of a solid electrolyte according to an embodiment, the preparing the solid electrolyte precursor may include: preparing a precursor raw material; milling the precursor raw material to form a milled product; and heat-treating the milled product to obtain a solid electrolyte precursor.

In the manufacturing method of a solid electrolyte according to an embodiment, the precursor raw material may include a sulfide-based raw material.

In the manufacturing method of a solid electrolyte according to an embodiment, the milling may be performed at 300 rpm to 500 rpm for 16 hours to 24 hours.

In the manufacturing method of a solid electrolyte according to an embodiment, the heat treatment may be performed at a temperature of 400 °C to 700 °C for 2 hours to 7 hours.

In the manufacturing method of a solid electrolyte according to an embodiment, the controlling the particle diameter may be performed at a temperature of −150 °C or lower.

In the manufacturing method of a solid electrolyte according to an embodiment, the controlling the particle diameter may include crushing the solid electrolyte precursor.

In the manufacturing method of a solid electrolyte according to an embodiment, the crushing the solid electrolyte precursor may be performed for 10 minutes to 3 hours.

A solid electrolyte according to the present disclosure may be prepared according to the manufacturing method of a solid electrolyte according to the present disclosure.

In the solid electrolyte according to an embodiment, a median particle diameter (D50) may be from 1 μm to 9 μm.

In the solid electrolyte according to an embodiment, a maximum particle diameter (Dmax) may be 11 μm or less.

In the solid electrolyte according to an embodiment, a SPAN value as defined by Equation 1 below may be 1.0 to 1.3.

SPAN=[(D90−D10)/D50] [Equation 1]

In the solid electrolyte according to an embodiment, the solid electrolyte may be a sulfide-based solid electrolyte.

In the solid electrolyte according to an embodiment, the sulfide-based solid electrolyte may include argyrodite-type sulfide.

In the solid electrolyte according to an embodiment, a room-temperature ionic conductivity may be 1 mS/cm to 3 mS/cm.

A secondary battery according to the present disclosure may include a solid electrolyte according to the present disclosure.

According to an aspect of the present disclosure, a manufacturing method of a solid electrolyte may be provided, which enables preparation of a solid electrolyte with an excellent performance through a process that is simple and economically feasible.

According to another aspect of the present disclosure, a solid electrolyte exhibiting excellent particle diameter properties and ionic conductivity may be provided.

According to another aspect of the present disclosure, a secondary battery having improved output characteristics, charge/discharge properties, lifespan, and safety may be provided.

### BRIEF DESCRIPTION OF THE DRAWINGS

FIG. 1 is a flowchart illustrating an example of a manufacturing method of a solid electrolyte according to an embodiment of the present disclosure.

### DETAILED DESCRIPTION

The embodiments described in the specification may be modified in many other forms and thus the technology according to an embodiment is not limited to the embodiments described below. Further, throughout the specification, unless otherwise specifically stated, references to “including,” “possessing,” “containing,” or “having” any component are not intended to exclude other components, but rather to indicate that other components may be further included, and are not intended to exclude elements, materials, or processes that are not additionally enumerated.

As used herein, identical or uniform may mean identical or uniform to each other within acceptable tolerances unless otherwise specified. For example, identical in composition or property measurements may encompass meaning that two objects being compared are identical within a margin of error, not just exactly the same. On the other hand, having the same physical property measurements may mean that the difference in the measurements between the objects is approximately less than 5%, more specifically less than 3%, and more specifically less than 1%.

In the specification, an angle between two objects being perpendicular, or mutually parallel or aligned to each other may include not only being geometrically perpendicular or parallel, but also within a small margin of error.

As used herein, numerical ranges include lower and upper limits and all values within those ranges, increments logically derived from the shape and width of the range being defined, all values that are doubly bounded, and all possible combinations of upper and lower limits of numerical ranges bounded in different ways.

Unless otherwise defined herein, the term “about” may be considered to be a value within 30%, 25%, 20%, 15%, 10%, or 5% of the stated value.

The use of the terms “first,” “second,” “third,” and the like before any component in this specification is intended to avoid confusion among components to which it refers, and is not intended to indicate any order, importance, or hierarchical relationship among the components. For example, an invention may be implemented that includes only a second component without a first component.

As used herein, the term “secondary battery” may refer to a battery that generates or stores electrical energy by oxidation and reduction reactions when ions, more specifically metal ions, such as lithium ions, are inserted and removed from a positive electrode and a negative electrode. Specifically, the term “secondary battery” may refer to any one of a lithium cobalt battery, a lithium high nickel battery, a lithium iron phosphate battery, a lithium ion battery, a lithium polymer battery, a lithium sulfur battery, a nickel hydrogen battery, a nickel cadmium battery, a sodium battery, and an all-solid-state battery.

As used herein, the term “solid electrolyte” may refer to, without limitation, any medium or substance of a solid nature, or any unit thereof, that may function as a transport medium for ions and at the same time delay, inhibit, or minimize the acceptance of electrons.

As used herein, the term “solid electrolyte precursor” may refer to, without limitation, any material that is in a process or manufacturing process prior to the final product form of the solid electrolyte. The process or manufacturing process as used herein may be physical or chemical.

As used herein, the term “particle diameter” may refer to an average length of major axis of a particle.

Hereinafter, the present disclosure will be described in detail. However, this is illustrative only, and the disclosure is not intended to be limited to the specific embodiments illustrated.

### Manufacturing Method of Solid Electrolytes

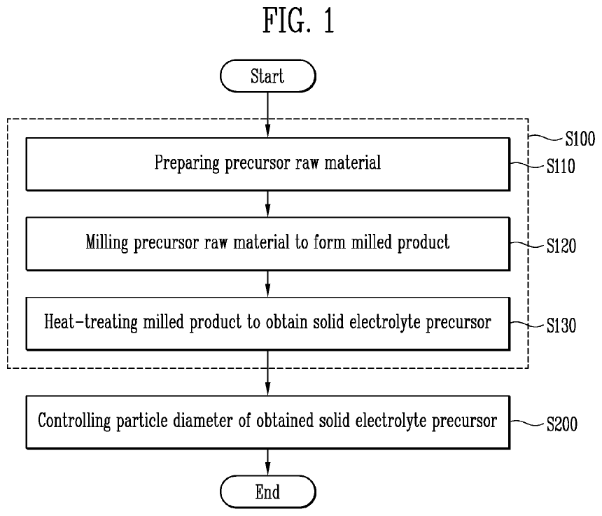

FIG. 1 is a flowchart illustrating an example of a manufacturing method of a solid electrolyte according to an embodiment of the present disclosure.

Referring to FIG. 1, the manufacturing method of a solid electrolyte according to an aspect of the present disclosure may include: preparing a solid electrolyte precursor S100; and controlling a particle diameter of the solid electrolyte precursor S200, wherein the controlling the particle diameter S200 may be performed at a temperature of 0 °C or lower.

In an embodiment, the solid electrolyte may be an oxide-based solid electrolyte or a sulfide-based solid electrolyte.

In a specific embodiment, the solid electrolyte may be a sulfide-based solid electrolyte.

In an exemplary embodiment, the sulfide-based solid electrolyte may include sulfur atoms.

As a non-limiting example, the sulfide-based solid electrolyte may include Li₂S—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, SiS₂—P₂S₅—ZₘSₙ (m and n are a positive number, and Z is Ge, Zn, or Ga), Li₂S—GeS₂, Li₂S—SiS₂—Li₂PO₄, Li₂S—SiS₂-LiₚMO_{q} (p and q are a positive number, and M is P, Si, Ge, B, Al, Ga, or In), Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2). They may be solely used or in combination of two or more.

In an embodiment, the sulfide-based solid electrolyte may include an argyrodite-type sulfide. In such an embodiment, the solid electrolyte may be an argyrodite-type sulfide-based solid electrolyte. The sulfide-based solid electrolyte including the argyrodite-type sulfide may be represented by Chemical Formula 1 below.

Li⁺₁₂₋ₙ₋ₓAⁿ⁺X²⁻₆₋ₓ Y⁻ₓ [Chemical Formula 1]

In the Chemical Formula 1 above, A is P, As, Ge, Ga, Sb, Si, Sn, Al, In, Ti, V, Nb, or Ta; X is S, Se, or Te; and Y is CI, Br, I, F, CN, OCN, SCN, or N₃, wherein 1≤n≤5 and 0≤x≤2.

As an exemplary embodiment, the sulfide-based solid electrolyte including the argyrodite-type sulfides include, without limitation, compounds that may be represented by Chemical Formula, Li₇₋ₓPS₆₋ₓYₓ (0≤x≤2, Y is Br, Cl, or I).

In the case of the sulfide-based solid electrolyte including the argyrodite-type sulfide, high ionic conductivity may be achieved, and due to a lack of precious metals, it is excellent in terms of economic and environmental aspects, with the advantage of excellent structural and chemical stability.

In an embodiment, to manufacture the solid electrolyte, a solid electrolyte precursor may be prepared.

Referring again to FIG. 1, in an embodiment, the preparing the solid electrolyte precursor S100 may include: preparing a precursor raw material S110; milling the precursor raw material to form a milled product S120; and heat-treating the milled product to obtain a solid electrolyte precursor S130.

In an embodiment, in the step S110, the precursor raw material may be prepared.

In an exemplary embodiment, the precursor raw material may include one or more types of raw materials. When the precursor raw material includes one or more types, the precursor raw material may be prepared as a mixture of one or more types of raw material.

In an embodiment, the precursor raw material may include a sulfide-based material. The sulfide-based raw material may include, without limitation, a sulfide phosphorus represented by PₓS_{y} (where x and y are natural numbers), and may include lithium sulfide, such as Li₂S. An example of the phosphorus sulfide is, but is not necessarily limited to, disulfide pentasulfide (P₂S₅).

In an embodiment, the precursor raw material may further include a lithium halide, such as lithium chloride (LiCl), other sulfur elementals, oxides, and the like.

In an embodiment, the mixture may refer to a physically or chemically mixed blend, and more specifically, the mixture may refer to a physically mixed blend.

In an embodiment, the mixture may be a simple mixture of multiple precursor raw materials in a solid state, for example, a simple mixture without undergoing any processing.

In an embodiment, in the step S120, the precursor raw material may be milled to form a milled product.

The milling is not particularly limited, but may be performed, for example, by ball milling. The ball milling may be performed via a dry or wet type, and more particularly by dry type. The balls used in the ball milling may include a metallic material, such as zirconia, and may have a diameter of, for example, 1 mm to 10 mm.

In an embodiment, the milling may be performed at 300 rpm to 500 rpm for 16 hours to 24 hours.

In a specific embodiment, the precursor raw material may be milled at 310 rpm or higher, 320 rpm or higher, 330 rpm or higher, 350 rpm or higher, 360 rpm or higher, 370 rpm or higher, or 380 rpm or higher, or 490 rpm or lower, 480 rpm or lower, 470 rpm or lower, 450 rpm or lower, 440 rpm or lower, 430 rpm or lower, or 420 rpm or lower. In addition, or alternatively, in a specific embodiment, the milling may be performed for 17 hours or longer, 18 hours or longer, 19 hours or longer, or 23 hours or shorter, 22 hours or shorter, or 21 hours or shorter.

When milling is performed below the above ranges, the milled product may not be properly milled, resulting in a large particle diameter or uneven distribution of the milled product, and when the milling is performed above the ranges, the ionic conductivity of the obtained solid electrolyte may be greatly reduced, which may be unfavorable in terms of processability.

In an embodiment, the step S120 may be performed in an inert atmosphere. In an exemplary embodiment, the step S120 may be performed in an argon gas atmosphere, but is not necessarily limited thereto.

In an embodiment, the step S120 may be performed at room temperature, but is not necessarily limited thereto.

In an embodiment, the milled product formed by the step S120 may be a pulverized product. In a specific embodiment, the milled product formed by the step S120 may be a ground product of the precursor raw materials (and/or mixtures thereof) prepared in the step S110.

In an exemplary embodiment, the milled product formed by the step S120, i.e., the ground product, may have a particle diameter of 10 μm to 500 μm. In an exemplary embodiment, the particle diameter of the majority of the ground product may be from 10 μm to 30 μm.

The particle diameter may be measured by a particle size measuring device, for example, a Mastersizer 3000 (Malvern). This may be applied in the same manner in the present specification.

In an embodiment, prior to step S130 to be described later, following the step S120, sieving and/or grinding the milled product using a sieve may further be included, but is not necessarily limited thereto.

In an embodiment, in the step S130, a solid electrolyte precursor may be obtained by heat-treating the milled product.

In an embodiment, the heat treatment may be performed at a temperature of 400 °C to 700 °C for 2 hours to 7 hours.

In a specific embodiment, the heat treatment may be performed at a temperature of 410 °C or higher, 420 °C or higher, 440 °C or higher, 450 °C or higher, 470 °C or higher, 500 °C or higher, 510 °C or higher, or 530 °C or higher, or 690 °C or lower, 680 °C or lower, 660 °C or lower, 650 °C or lower, 640 °C or lower, 620 °C. or lower, 600 °C or lower, 590 °C or lower, or 580 °C or lower. In addition, or alternatively, in a specific embodiment, it may be performed for 3 hours or longer, or 4 hours or longer, or 6 hours or shorter.

When performed below the ranges, the crystal structure of the solid electrolyte particles may be hardly formed, and when performed above the ranges, elements such as sulfur(S) or phosphorus (P) among elements constituting the solid electrolyte may be volatilized, making it difficult to obtain a solid electrolyte of the desired composition. In particular, when sulfur is volatilized, the ionic conductivity of the obtained solid electrolyte may deteriorate.

In an embodiment, sieving and/or grinding the solid electrolyte precursor obtained after the step S130 using a sieve may further be included, but is not necessarily limited to.

In an embodiment, a solid electrolyte precursor may be acquired by the steps including steps S110, S120, and S130 above. The solid electrolyte precursor thus obtained may be substantially the same or similar at least in composition to the finally manufactured solid electrolyte, but may have different properties, such as average particle diameter.

Referring again to FIG. 1, in an embodiment, in the controlling the particle diameter of the solid electrolyte precursor S200, the particle diameter of the solid electrolyte precursor may be controlled.

In an embodiment, the step S200 may be performed in a low temperature environment, for example at a temperature below 0 °C or lower.

In a specific embodiment, the step S200 may be performed in a cryogenic environment. Specifically, the controlling the particle diameter S200 may be performed at a temperature of −100 °C or lower, and in a more specific embodiment, the controlling the particle diameter S200 may be performed at a temperature of −150 °C or lower. More specifically, the temperature may be −160 °C or lower, −170 °C or lower, −180 °C or lower, or −190 °C or lower.

In an exemplary embodiment, the controlling the particle diameter S200 may be performed at a temperature of −250 °C or higher, −240 °C or higher, −230 °C or higher, −220 °C or higher, −210 °C or higher, or −200 °C or higher. When the controlling is performed at a temperature range lower than the above-mentioned temperature range, the degree of improvement in the effects described below due to the creation of a cryogenic environment may be negligible compared to the energy input required to establish such temperature conditions. Therefore, issues may arise from an economic or operational standpoint.

To create such a low temperature environment, particularly a cryogenic environment, for example, any space in which the step S200 is carried out may be cooled using a refrigerant. In an exemplary embodiment, a liquified material of inert gas may be used as a refrigerant to rapidly cool the space, such as, but not necessarily limited to, liquid nitrogen.

In an exemplary embodiment, any space in which step S200 is performed may be cooled by rapid cooling for 1 to 10 minutes after pre-cooling for 8 to 15 minutes, but is not necessarily limited thereto.

In an embodiment, the controlling the particle diameter S200 may include crushing the solid electrolyte precursor. The crushing may be accomplished by any known crushing method, including, without limitation, milling as described above, as well as mechanical or physical crushing methods, as appropriate.

In such embodiments, the step S200 may refer to cold grinding, specifically cryogenic grinding or freeze grinding, of the solid electrolyte precursor prepared in the step S100. By performing step S200 under the conditions described above, it is possible to finely grind the individual particles so that the particle diameters are generally in the range of several micrometers (μm), and furthermore, the grinding may be readily performed with less energy applied to the individual particles, thereby preventing deterioration of the material, such as loss of surface crystallinity.

When the step S200 is carried out at a temperature below the numerical range above, such as below −100 °C, or below −150 °C, it may be difficult to realize the aforementioned effects of creating a cryogenic environment.

In an embodiment, the controlling the particle diameter S200 may be performed after the preparing the solid electrolyte precursor S100. In a specific embodiment, the controlling the particle diameter S200 may be performed after the heat-treating the milled product S130.

By performing the step S200 after the step S130, it is possible to control the particle size after the phase stability of the material has been secured, thereby obtaining a stoichiometrically accurate material and controlling the particle size in different ranges for different purposes depending on the processing time.

In an embodiment, the controlling the particle diameter S200 may be performed for 10 minutes to 3 hours. In a specific embodiment, it may be performed for 20 minutes or longer, 25 minutes or longer, or 160 minutes or shorter, 150 minutes or shorter, 130 minutes or shorter, 120 minutes or shorter, 100 minutes or shorter, or 80 minutes or shorter.

When performed below the above ranges, the solid electrolyte precursor may not be ground properly to result in large particle size or uneven distribution of the solid electrolyte, and when performed above the ranges, additional degradation in the material may take place.

The manufacturing method of a solid electrolyte according to an aspect of the present disclosure may employ any known process that may be used in the manufacturing of a solid electrolyte other than the steps S100 and S200, without limitation.

The manufacturing method of a solid electrolyte according to an aspect of the present disclosure enables simple and effective controlling of the particle size of the solid electrolyte, while preventing material degradation during the process. Accordingly, the manufacturing method of a solid electrolyte according to an aspect of the present disclosure may enable simple and effective preparation of a solid electrolyte with excellent properties as described later.

### Solid Electrolytes

The solid electrolyte according to an aspect of the present disclosure may be prepared according to the manufacturing method of a solid electrolyte according to an aspect of the present disclosure described above.

In an embodiment, the solid electrolyte may be an oxide-based solid electrolyte or a sulfide-based solid electrolyte, and in a specific embodiment, the solid electrolyte may be a sulfide-based solid electrolyte, and in a further specific embodiment, the sulfide-based solid electrolyte may include argyrodite-type sulfide. The above description for the solid electrolyte may be equally applicable to the manufacturing method of a solid electrolyte described above with reference to FIG. 1, and therefore, redundant descriptions will be omitted in the following.

In an embodiment, the solid electrolyte may have a median particle diameter (D50) of 1 μm to 9 μm. In other words, in an embodiment, the solid electrolyte according to an aspect of the present disclosure may be prepared according to the manufacturing method of a solid electrolyte according to an aspect of the present disclosure, and may have a median particle diameter (D50) of 1 μm to 9 μm. Specifically, the median particle diameter may be 1.3 μm or greater, 1.5 μm or greater, 1.8 μm or greater, 2 μm or greater, 2.5 μm or greater, 2.8 μm or greater, 3 μm or greater, 3.5 μm or greater, or 8 μm or less, 7.7 μm or less, 7.5 μm or less, 7.2 μm or less, or 7 μm or less.

Here, the median particle diameter may exemplarily refer to the particle diameter when the cumulative volume reaches 50% from the smallest particle diameter in the particle size distribution derived from the particle diameter measurement method described above.

In an embodiment, the room-temperature ionic conductivity of the solid electrolyte may be from 1 mS/cm to 3 mS/cm. More specifically, the room-temperature ionic conductivity may be 1.2 mS/cm or greater, 1.3 mS/cm or greater, 1.5 mS/cm or greater, 1.7 mS/cm or greater, or 2.9 mS/cm or less, 2.8 mS/cm or less, 2.7 mS/cm or less, 2.6 mS/cm or less, 2.5 mS/cm or less, 2.3 mS/cm or less, 2.2 mS/cm or less, or 2.1 mS/cm or less.

In this case, the ionic conductivity may be measured using, for example, alternating current impedance measurement in a room temperature environment.

In an embodiment, the solid electrolyte may have a maximum particle diameter (Dmax) of 11 μm or less. In other words, in an embodiment, the solid electrolyte according to an aspect of the present disclosure may be prepared according to the manufacturing method of a solid electrolyte according to an aspect of the present disclosure, and may have a maximum particle diameter (Dmax) of 11 μm or less. In a specific embodiment, the maximum particle diameter may be 10.9 μm or less, 10.8 μm or less, 10.7 μm or less, 10.6 μm or less, or 10.5 μm or less. In this case, the maximum particle diameter may exemplarily refer to the particle diameter (D99) when the cumulative volume reaches 99% from the smallest particle diameter in the particle size distribution derived from the particle diameter measurement method described above.

In an embodiment, the solid electrolyte may have a SPAN value of 1.0 to 1.3 as defined by Equation 1 below.

SPAN=[(D90−D10)/D50] [Equation 1]

In Equation 1, D50 may be the same as described above, and D90 and D10 may refer to particle diameters when the cumulative volumes reach 90% and 10%, respectively, from smallest particle diameters in a particle size distribution derived from the particle diameter measurement method described above.

In an embodiment, the solid electrolyte according to an aspect of the present disclosure may be prepared according to the manufacturing method of a solid electrolyte according to an aspect of the present disclosure, wherein the span value may be from 1.0 to 1.3. In a specific embodiment, the span value may be 1.02 or greater, 1.05 or greater, 1.06 or greater, 1.08 or greater, or 1.1 or greater, or 1.28 or less, 1.26 or less, 1.25 or less, 1.24 or less, or 1.22 or less.

The solid electrolyte according to an aspect of the present disclosure may exhibit the particle diameter, particle diameter distribution, and ionic conductivity as described above.

In such embodiments, the solid electrolyte according to an aspect of the present disclosure may be particularized to have an excellent particle diameter and particle diameter distribution, which may improve the energy density of a secondary battery including the solid electrolyte, and may improve the contact properties with an active material.

In other embodiment, in the process of manufacturing a battery cell, the solid electrolyte is composed of a thin film (approximately 30 μm in thickness), and when the solid electrolyte is not particularized to the same extent as described above, large solid electrolyte particles may be sporadically distributed on the surface of the film, which may eventually cause a short circuit in the finally manufactured battery cell.

Furthermore, the degradation in the ionic conductivity of the solid electrolyte according to an aspect of the present disclosure may be prevented to lead to reduction in the internal resistance between the positive electrode and the negative electrode, and therefore the output characteristics, charge/discharge characteristics, and lifespan of a secondary battery including the same may be improved.

### Secondary Battery

A secondary battery according to an aspect of the present disclosure may include: a positive electrode; a negative electrode; and the solid electrolyte according to an aspect of the present disclosure.

In an embodiment, the positive electrode may include a positive electrode collector and a positive electrode composite layer formed on at least one surface of the positive electrode collector.

The positive electrode collector may include stainless steel, nickel, aluminum, titanium, or an alloy thereof. The positive electrode collector may include aluminum or stainless steel, surface-treated with carbon, nickel, titanium, or silver. The positive electrode collector may be, for example, but not limited to, 10 to 50 μm.

The positive electrode composite layer may include a positive electrode active material. The positive electrode active material may include a compound capable of reversibly intercalating and deintercalating metal ions, more specifically lithium ions.

The positive electrode active material may include a lithium-nickel metal oxide. The lithium-nickel metal oxide may further include at least one of cobalt (Co), manganese (Mn), and aluminum (Al).

In some embodiments, the positive electrode active material may include a lithium cobalt oxide-based active material, a lithium manganese oxide-based active material, a lithium nickel oxide-based active material, or a lithium iron phosphate (LFP)-based active material (e.g., LiFePO₄).

The positive electrode composite layer may further include a positive electrode binder and a conductive material. The positive electrode composite layer may further include a thickener, if necessary. In some embodiments, the positive electrode binder may include polyvinylidenefluoride (PVDF), poly(vinylidene fluoride-co-hexafluoropropylene), polyacrylonitrile, polymethylmethacrylate, butadiene rubber, or the like. In an embodiment, a PVDF-based binder may be used as the positive electrode binder.

The conductive material may be added to enhance the conductivity and/or mobility of lithium ions or electrons in the positive electrode composite layer. For example, the conductive material may include, but is not limited to, carbon-based conductive materials such as graphite, carbon black, acetylene black, Ketjenblack, graphene, carbon nanotubes (CNTs), vapor-grown carbon fiber (VGCF), carbon fiber, or the like and/or metal-based conductive materials including perovskite materials such as tin, tin oxide, titanium oxide, LaSrCoO₃, or LaSrMnO₃.

The positive electrode composite layer may further include known thickeners and/or dispersants, if necessary.

In an embodiment, the negative electrode may include a negative electrode collector and a negative electrode composite layer formed on at least one surface of the negative electrode collector.

The negative electrode composite layer may include a negative electrode active material. In an exemplary embodiment, a material capable of adsorbing and desorbing metal ions, specifically lithium ions, may be used as the negative electrode active material. For example, a carbon-based material such as crystalline carbon, amorphous carbon, carbon composite, carbon fiber, or the like; lithium metal; lithium alloy; silicon (Si)-containing material or tin (Sn)-containing material may be used as the negative electrode active material.

Examples of amorphous carbon include hard carbon, soft carbon, coke, mesocarbon microbeads (MCMB), mesophase pitch-based carbon fiber (MPCF), and the like.

Examples of the crystalline carbon include graphitic carbons such as natural graphite, artificial graphite, graphitized coke, graphitized MCMB, graphitized MPCF, and the like.

The lithium metal may be pure lithium metal or lithium metal with a protective layer formed for suppression of dendrite growth.

The elements included in the lithium alloy may include aluminum, zinc, bismuth, cadmium, antimony, silicon, lead, tin, gallium, or indium.

The silicon-containing material may provide increased capacity characteristics. The silicon-containing material may include Si, SiOₓ (0<x<2), metal-doped SiOₓ (0<x<2), silicon-carbon composites, and the like. The metal may include lithium and/or magnesium, and the metal-doped SiOₓ (0<x<2) may include a metal silicate.

Non-limiting examples of solvents for the negative electrode active material include water, pure water, deionized water, distilled water, ethanol, isopropanol, methanol, acetone, n-propanol, t-butanol, and the like.

In an embodiment, the negative electrode may further include a binder, and optionally may further include additives such as conductive materials, thickeners, dispersants, and the like.

In an embodiment, the solid electrolyte may be configured in a form interposed between the positive electrode and the negative electrode.

In an exemplary embodiment, it may be configured as a solid electrolyte layer including the solid electrolyte. The solid electrolyte layer may be formed, for example, on at least one of the positive electrode and the negative electrode.

In an exemplary embodiment, the solid electrolyte layer may be formed on the positive electrode composite layer and/or the negative electrode composite layer. In such embodiments, the solid electrolyte may be formed in a slurry to be cast onto the positive electrode composite layer and/or the negative electrode composite layer, or the solid electrolyte may be formed in a dry film to be laminated onto the positive electrode composite layer and/or the negative electrode composite layer to form the solid electrolyte layer.

In an exemplary embodiment, the solid electrolyte layer may be formed on a positive electrode collector and/or a negative electrode collector. In such embodiments, the solid electrolyte may be formed in a slurry to be cast on any one surface of the positive electrode collector and/or the negative electrode collector, or the solid electrolyte may be formed in a dry film to be laminated on at least any one surface of the positive electrode collector and/or the negative electrode collector to form the solid electrolyte layer.

In the positive electrode and the negative electrode where the solid electrolyte layer is formed, the secondary battery may be formed such that the solid electrolyte layer is interposed between each composite layer.

In another embodiment, the solid electrolyte layer may be prepared in the form of a free-standing membrane, and the secondary battery may be configured such that a solid electrolyte layer in the form of a free-standing membrane is interposed between the positive electrode and the negative electrode.

Alternatively, the secondary battery may be configured as a composite electrode including the solid electrolyte in the positive electrode composite layer and/or the negative electrode composite layer.

The secondary battery may further include a liquid electrolyte or gel-electrolyte including a non-aqueous electrolyte, including a lithium salt and an organic solvent, if necessary.

In such embodiments, the lithium salt is represented, for example, by Li⁺X⁻, and examples of the anions (X⁻) of the lithium salt may include F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF, (CF₃)₆P⁻, CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, or (CF₃CF₂SO₂)₂N⁻.

The organic solvent may include an organic compound that has sufficient solubility for the lithium salt and is not reactive in the cell. The organic solvent may include, for example, at least one of a carbonate-based solvent, an ester-based solvent, an ether-based solvent, a ketone-based solvent, an alcohol-based solvent, and an aprotic solvent.

The secondary battery may further include a separator, if necessary.

In such embodiments, the separator may be configured to prevent a physical short circuit between the electrodes, while still allowing the flow of ions to occur. The separator may include a material that is meltable upon exposure to high temperatures, for example, polyolefin-based polymers, such as ethylene polymers, propylene polymers, ethylene/butene copolymers, ethylene/hexene copolymers, and ethylene/methacrylate copolymers, or high melting point glass fibers, polyethylene terephthalate fibers, or the like.

An electrode assembly may be formed, including the positive electrode, the solid electrolyte, and the negative electrode. The electrode assembly may be divided into a winding type, a stacking type, a z-folding type, a stack-folding type, and the like depending on the form it is configured.

In other embodiments, a battery cell may be manufactured by accommodating the electrode assembly in a case. The battery cell may be categorized as a pouch-type, can-type, coin-type battery cell, or the like, depending on the shape of the electrode assembly and/or the case.

The secondary battery according to an aspect of the present disclosure may be used in a battery cell that is employed as a power source for a small device, but may also be preferably used as a unit cell in a battery module of a medium to large device including a plurality of battery cells. Examples of such small devices may include, but are not limited to, cell phones, laptop computers, cameras, and the like, and examples of such medium to large devices may include, but are not limited to, electric vehicles, hybrid electric vehicles, plug-in hybrid electric vehicles, power storage systems, and the like.

In the following, embodiments of the present disclosure will be further described with reference to specific experimental examples. The examples and comparative examples included in the experimental examples are illustrative of the present disclosure and are not intended to limit the scope of the appended patent claims, and it will be apparent to those skilled in the art that various changes and modifications to the embodiments are possible within the scope and spirit of the present disclosure, where such changes and modifications fall within the scope of the appended patent claims.

### Examples

### 1. Preparation of Solid Electrolytes

Lithium sulfide (Li₂S), phosphorus pentasulfide (P₂S₅), and lithium chloride (LiCl) were prepared in a molar ratio of 5:1:2 by weighing each in a glove box under an argon gas atmosphere, and then ground in a planetary ball mill containing zirconia balls at 400 rpm for 20 hours. After grinding, the ground product in a powder form was recovered by sieving and induction grinding. The recovered ground product was heat-treated in an argon gas atmosphere at a temperature of about 550 °C for about 5 hours. After going through the heat treatment, the powdered solid electrolyte precursor was recovered by sieving and induction grinding.

The recovered solid electrolyte precursor was inserted in a sealed vial in the glove box along with the impactor, which is a grinding device. Before placing the vials in the crusher, to undergo a pre-cooling operation, liquid nitrogen was used to create a cryogenic environment at −196 °C, after which the vials were placed and crushed in the cryogenic environment to carry out freeze crushing. After grinding, only the vials were taken, and the solid electrolyte was recovered from the glove box to prepare the solid electrolyte. The conditions for the freeze grinding were as shown in Table 1 below.

TABLE 1

| | | |
|---|---|---|
| Pre cool | 10 | min |
| Run | 2 | min |
| Cool | 1 | min |

| | |
|---|---|
| Cycle | 30 |

Sample 1 and Sample 2 were recovered from the freeze grinding process by setting different grinding times. The Sample 1 was ground for 30 minutes, while the Sample 2 was ground for 1 hour.

### 2. Evaluation of the Properties of the Prepared Solid Electrolytes

The physical properties of the solid electrolytes prepared above were evaluated, specifically for the Sample 1 and 2.

The Samples 1 and 2 were evaluated for particle diameter using a laser diffraction particle size analyzer (LA-960V2, Horiba), specifically, the samples were dispersed in a solvent before particle size measurement using a wet dispersion module, and the particle size distribution was analyzed by laser diffraction. Before the measurement, the dispersant and sample refractive index were set, the transmittance was adjusted, and the optimal concentration was dosed and measured automatically. The results for the particle size measurement are shown in Table 2 below.

In other embodiments, the Samples 1 and 2 were evaluated for room-temperature ionic conductivity using a Potentiostat (VMP-300, BioLogic), specifically, the samples were pressurized at 300 Mpa to form a mold (diameter 10 mm, thickness 0.7 mm) for measurement, and alternating impedance was measured for the mold at room temperature. The measurement was performed at 10 mV with a start frequency of 7 MHz and an end frequency of 100 Hz, the results of which are shown in Table 2 below.

TABLE 2

| | | | | Ionic Conductivity |
|---|---|---|---|---|
| Classification | D50 (μm) | D99 (μm) | SPAN | (mS/cm) |
| Sample 1 | 6.6 | 10.4 | 1.21 | 1.85 |
| Sample 2 | 4.1 | 9.2 | 1.15 | 1.73 |

*SPAN: (D90 − D10)/D50

Referring to Table 2 above, it was found that the solid electrolyte prepared according to the manufacturing method according to an aspect of the present disclosure may have a small particle diameter with the particle diameter evenly controlled, and exhibit a high level of room-temperature ionic conductivity.

What is claimed is:

1. A manufacturing method of a solid electrolyte, comprising:
preparing a solid electrolyte precursor; and
controlling a particle diameter of the solid electrolyte precursor,
wherein the controlling the particle diameter is performed at a temperature of 0 °C or lower.

2. The manufacturing method according to claim 1, wherein the solid electrolyte is a sulfide-based solid electrolyte.

3. The manufacturing method according to claim 2, wherein the sulfide-based solid electrolyte includes argyrodite-type sulfide.

4. The manufacturing method according to claim 1, wherein the preparing the solid electrolyte precursor includes:
preparing a precursor raw material;
milling the precursor raw material to form a milled product; and
heat-treating the milled product to obtain a solid electrolyte precursor.

5. The manufacturing method according to claim 4, wherein the precursor raw material includes a sulfide-based raw material.

6. The manufacturing method according to claim 4, wherein the milling is performed at 300 rpm to 500 rpm for 16 hours to 24 hours.

7. The manufacturing method according to claim 4, wherein the heat treatment is performed at a temperature of 400 °C to 700 °C for 2 hours to 7 hours.

8. The manufacturing method according to claim 1, wherein the controlling the particle diameter is performed at a temperature of −150 °C or lower.

9. The manufacturing method according to claim 1, wherein the controlling the particle diameter includes crushing the solid electrolyte precursor.

10. The manufacturing method according to claim 9, wherein the crushing the solid electrolyte precursor is performed for 10 minutes to 3 hours.

11. A solid electrolyte manufactured according to the manufacturing method of claim 1.

12. The solid electrolyte according to claim 11, wherein a median particle diameter (D50) is from 1 μm to 9 μm.

13. The solid electrolyte according to claim 11, wherein a maximum particle diameter (Dmax) is 11 μm or less.

14. The solid electrolyte according to claim 11, wherein a SPAN value as defined by Equation 1 below is 1.0 to 1.3:
SPAN=[(D90−D10)/D50] [Equation 1]

15. The solid electrolyte according to claim 11, wherein the solid electrolyte is a sulfide-based solid electrolyte.

16. The solid electrolyte according to claim 15, wherein the sulfide-based solid electrolyte includes argyrodite-type sulfide.

17. The solid electrolyte according to claim 11, wherein a room-temperature ionic conductivity is 1 mS/cm to 3 mS/cm.

18. A secondary battery comprising:
a positive electrode;
a negative electrode; and
the solid electrolyte according to claim 11.
